(19) United States
(12) Patent Application Publication
(10) Pub. No.: US 2005/0248810 A1
(43) Pub. Date: Nov. 10, 2005

(54) Method for making a digital representation of a printed product in steps

(76) Inventors: Chris Tuijn, Lier (BE); Peter De Mangelaere, Deinze (BE)

Correspondence Address: AGFA CORPORATION;LAW & PATENT DEPARTMENT, 200 BALLARDVALE STREET, WILMINGTON, MA, 01887, US

(21) Appl. No.: 11/122,691

(22) Filed: May 5, 2005

Related U.S. Application Data
(60) Provisional application No. 60/576,919, filed on Jun. 4, 2004.

(30) Foreign Application Priority Data
May 6, 2004 (EP) 04076346.8

(51) Int. Cl. G06K 15/02

(52) U.S. Cl. 358/1.18

(57) ABSTRACT

A method for making a digital representation of a printed product includes: getting first input data including data selected from the group of a total number of content pages of the printed product and a cover type of the printed product; generating from the first input data a first digital representation of the printed product; getting second input data, different from the first input data; and refining the first digital representation of the printed product by using the second input data, thus obtaining a second digital representation of the printed product.

This application claims the benefit of U.S. Provisional Application No. 60/576,919 filed on Jun. 4, 2004.

### FIELD OF THE INVENTION

The present invention relates to printed products and particularly to making a digital representation of a printed product.

### BACKGROUND OF THE INVENTION

In the printing and publishing environment, different players interact in order to obtain print and publishing products, such as magazines, catalogues, promotional, corporate, book or specialty products in offset, flexo, screen, digital, sheet- or web-fed printing. Such products are called “printed products” in this document. The main players that interact, in what is called in this document the “Graphic Enterprise”, are the print buyer (or customer), the people in the workcenter, and the customer service representative (CSR) who is the communicator between the first two main players.

Different software tools are used within the Graphic Enterprise, such as pre-press workflow systems (such as Apogee Series 3 and ApogeeX from Agfa), cost estimation modules, Management Information Systems (MIS), etc. Most of these tools operate on a digital representation of the product that will be printed.

When organizing and streamlining the work within the Graphic Enterprise, the method according to which the digital representation of the printed product is obtained and also the way in which the printed product will be manufactured play a central role.

A method for creating a digital representation of a printed product is disclosed in patent application U.S. 2004/0187073 A1, herein incorporated by reference in its entirety for background information only. There is still a need for an improved method for making a digital representation of a printed product.

### SUMMARY OF THE INVENTION

A method for making a digital representation of a printed product includes: getting first input data including data selected from the group of a total number of content pages of the printed product and a cover type of the printed product; generating from the first input data a first digital representation of the printed product; getting second input data, different from the first input data; and refining the first digital representation of the printed product by using the second input data, thus obtaining a second digital representation of the printed product.

Preferably, a method in accordance with the invention is implemented by a computer program. The invention also includes a data processing system (such as a computer, a computer network system, etc.) including means for carrying out such a method and a computer readable medium including program code adapted to perform such a method. The invention further includes the printed product that is produced while using a digital representation made in accordance with such a method.

A particular embodiment of the invention is encompassed in a project management system that organizes and streamlines the work within the Graphic Enterprise. In this system, and in the corresponding method, first a coarse digital representation of a printed product is made, based on a first set of input data. Then, a second set of input data is added, and a finer digital representation of the printed product is made, based on the first and the second set of input data. Thus, the coarse digital representation, made in a first step, is refined in a second step.

One embodiment in accordance with the invention includes a computer program product for making a digital representation of a printed product, the computer program product including:
first program instructions for getting first input data that include data selected from the group of a total number of content pages of said printed product and a cover type of said printed product;
second program instructions for generating from said first input data a first digital representation of said printed product;
third program instructions for getting second input data, different from said first input data; and
fourth program instructions for refining said first digital representation of said printed product by using said second input data, thus obtaining a second digital representation of said printed product.

The computer program product may further include a computer readable medium wherein said first, second, third and fourth program instructions are recorded on said medium.

Another embodiment in accordance with the invention includes a computer program product for making a digital representation of a printed product, the computer program product including:
first program instructions for getting first input data that are derived from specifications of said printed product as determined by a customer;
second program instructions for generating from said first input data a first digital representation of said printed product;
third program instructions for getting second input data that are different from said first input data and that are purely related to producing said printed product; and
fourth program instructions for refining said first digital representation of said printed product by using said second input data, thus obtaining a second digital representation of said printed product.

The computer program product may further include a computer readable medium wherein said first, second, third and fourth program instructions are recorded on said medium.

Yet another embodiment in accordance with the invention includes a system for making a digital representation of a printed product, the system including:
a first input module for getting first input data that include data selected from the group of a total number of content pages of said printed product and a cover type of said printed product;
a generator for generating from said first input data a first digital representation of said printed product;
a second input module for getting second input data, different from said first input data; and
a refinement module for refining said first digital representation of said printed product by using said second input data, thus obtaining a second digital representation of said printed product.

In this document, a part, a page and other suchlike terms may denote the physical entity; it may denote the digital representation of the physical entity. What is meant, can be determined from the context.

A computer program denotes, in this document, an aggregate of computer program code means, that may be organized in one entity, or in a plurality of entities that may run independently of each other (e.g. generating the first, coarse digital representation of the printed product may be performed by a first entity, and refining the first, coarse digital representation to obtain a second, finer digital representation of the printed product may be performed by a second entity; both entities together are denoted, in this document, as “a computer program”).

### BRIEF DESCRIPTION OF THE DRAWINGS

The invention is described with reference to the following drawing without the intention to limit the invention thereto, and in which:

FIG. 1 diagrammatically shows an embodiment in accordance with the invention.

### DETAILED DESCRIPTION OF THE PREFERRED EMBODIMENTS

In a preferred embodiment of the invention, the first, coarse, digital representation represents those features of the printed product that are important for the customer, since they specify what the printed product will look like, while the finer digital representation also includes features that are important for the production process of the printed product.

The first input data on which the coarse digital representation is based preferably include data selected from the group of the cover type, the number of content pages, the binding method, the number of inserts (if present), the used colors; more preferably, the first input data include all of these data. Even more preferably, the first input data do not include the exact, detailed binding method that defines how the sections are gathered together (such as saddle-stitched or perfect bound) but the first input data include instead the category of binding method that is to be used—such as glued, sewn, single-leaf bound (e.g. ring bound), loose-leaf bound (as used e.g. for newspapers)—determining the appearance of the printed product and hence important for the customer. Further, the first input data preferably also include the page orientation (portrait or landscape).

In a less preferred embodiment of the invention, the first input data include data selected from the group of a total number of content pages of the printed product and a binding method of the printed product.

The cover type may be self-cover, which means that there is no separate cover: the outer pages of the content serve as the cover; it may be separate cover—same binding as content; it may be separate cover—additional binding.

An insert is printed material, typically one or more advertisements, that is inserted between the content pages. Usually, inserts do not affect the pagination of the content; if e.g. an insert of four pages is located between page seven and page eight of the content, page eight retains its page number and does not get page number twelve.

The number of sections of the printed product, and the number of pages of the sections, are preferably included in the second input data, not in the first input data (an exception is for example the case where certain pages, e.g. eight specific pages, have to be printed in color while the rest of the printed product is printed in black-and-white; in that case, the eight color pages will form a section, and those data belong to the first input data since they are important for the customer). It is further preferred that the second input data include how the sections are gathered together (e.g. saddle-stitched or perfect bound). Remark: a number of individual pages are normally printed on the same sheet; a “section” is the entity that is obtained by folding that sheet, after printing, by a folding machine.

Thus, it is preferred that the input data are split in two categories: first input data that are customer-related, or, put otherwise, that are derived from the specifications of the printed product as determined by the customer, and second input data that are purely production-related (such as the number of sections). The first, coarse, digital representation is made based on these first input data.

In a very preferred embodiment of the invention, the first input data include data selected from the group of a total number of content pages of the printed product and a cover type of the printed product, and the second input data are different from the first input data. Further, the second input data preferably includes a number of sections of the printed product.

In one preferred embodiment of the invention, when the second, finer digital representation of the printed product is made, the first, coarse digital representation is not affected (i.e. it is just refined); only after approval of the customer, the first digital representation may be affected (and the first input data changed). Refining the first digital representation may be done in several sub-steps, iteratively, by the use of more and more production-related input data (while keeping the first input data unchanged). Examples of production-related data are: the available presses, which determine a.o. the size of the sections; the number of copies of the printed product that have to be made, which determines what presses can be used.

Refining the digital representation in this way is advantageous since the first, coarse representation of the printed product is kept unchanged. This is of importance because this first, coarse digital representation preferably represents the features of the printed product that are important for the customer, since they specify what the printed product will look like. Thus, one may be sure that these features are not changed except on purpose.

Another advantage is that changes in production can easily be countered. Suppose e.g. that the refined digital representation of the printed product was generated for a set of presses including a 32-up press, and suppose that, when the printed product has to be printed, only 16-up presses are available. Thus, the sections of the printed product that would have been printed on the 32-up press, and that thus had sixty-four pages (thirty-two pages at the front side of the sheet printed on the press and thirty-two pages at the back side) have to be replaced by sections of thirty-two pages. Such a change may be implemented by changing the number of sections, and the number of pages per section, and by regenerating the refined digital representation of the printed product in response to these changed input data.

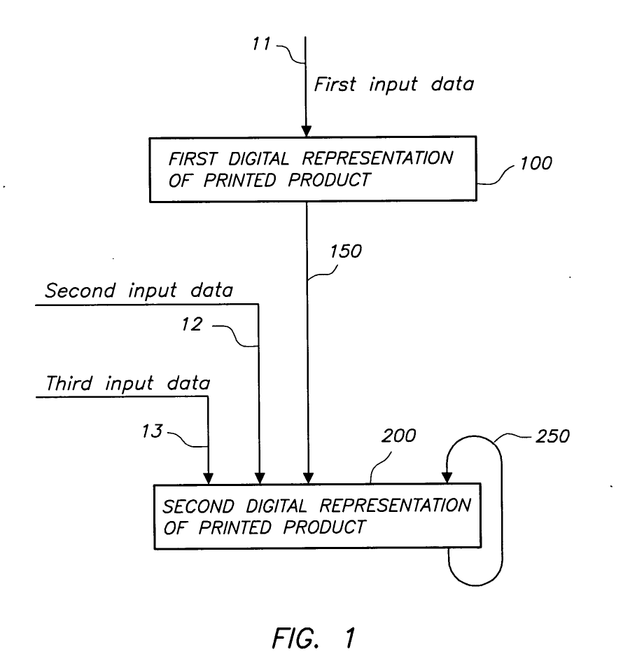

FIG. 1 diagrammatically illustrates this preferred embodiment of the invention. A first digital representation 100 of a printed product is generated from first input data 11. Then, second input data 12 are input and are used to refine—which is indicated by arrow 150—the first digital representation 100, so that a second digital representation 200 of the printed product is obtained. Now, iteratively, the digital representation of the printed product may still be further refined by inputting additional data, e.g. third input data 13. This iterative process is indicated in FIG. 1 by loop 250. Thus, the original digital representation 100 (and the original data structure) may be kept, and further refined by adding more and more details.

Alternatively, input data may be changed (as illustrated by the example of the 32-up press discussed above), the changed input data resulting in a changed digital representation of the printed product.

Preferably, the first input data include all data that are required to make a digital representation of the printed product that allows content matter to be associated to the pages. Associating content matter to the pages is typically done by the end-user. Content matter is e.g. an image or a text that has to appear in a given location in the printed product. It is assumed that the content matter is available as a set of files of data.

Content matter may be associated to pages as follows, by means of so-called naming lists. Pages are assigned to naming lists, taking into account the naming convention of the files with content matter. There are two kinds of naming lists. Whereas the “internal naming lists” are used to label the pages internally, the “external naming lists” will have a direct mapping to the filename conventions the customer (or the company that delivers the content matter) will use. The project management system can then start accepting the files that contain the content matter.

For more details on the implementation of one embodiment of a method for making a digital representation of a printed product in accordance with the invention, it is referred to patent application EP 04 076 346.8, pages 7 to 15; these pages are herein incorporated by reference for background information only.

The input data that are used to generate the digital representation of the printed product may be obtained from a user, who is typically the customer service representative (CSR) mentioned already above. The input data may be obtained via a computer display. The input data relate to different portions of the printed product: the cover, the content, inserts, that are called “parts” in the digital representation in accordance with the invention.

The invention is now illustrated by means of the following, very simple, example.

A notebook has to be made. The first input data, used for the first, coarse digital representation of this printed product, are: hard cover; 256 pages; sewn; page size: A5 portrait, i.e. width 148 mm and height 210 mm. Now, for the first digital representation, a first part is created for the cover, and a second part for the content, i.e. 256 pages. Naming lists are associated to these parts. The parts may be visualized in so-called reader spread view (for a discussion of reader spread view, see patent application EP 04 076 346.8, mentioned already above). The first digital representation includes a flat structure, of cover and content, that may be represented by the following notation:
COVER(4)<CONTENT(256)

In the above notation, the amount (4, respectively 256) indicates the number of pages, the horizontal axis models insertion, and the vertical axis (not used above, but illustrated further below) models stacking. Thus, the notation above indicates that 256 content pages are inserted in four cover pages.

Suppose that the coarse digital representation is now refined in a second step: there are to be sections of 96 and of 64 pages, and the gathering of the sections is to be perfect bound:

$$\begin{matrix}COVER ( 4 ) < CONTENT ( 96 ) \\ < CONTENT ( 96 ) \\ < CONTENT ( 64 )\end{matrix}$$

Thus, in the second step, the digital representation gets more structure, is refined, based on second input data that are production-related.

Just to illustrate the used notation, the following is an example of a saddle stitched printed product:
COVER(4)<CONTENT(96)<CONTENT(96)<CONTENT(64)

Those skilled in the art will appreciate that numerous modifications and variations may be made to the embodiments disclosed above without departing from the scope of the present invention.

### LIST OF REFERENCE SIGNS

11: input data
12: input data
13: input data
100: digital representation
150: arrow
200: digital representation
250: loop

1. A method for making a digital representation of a printed product comprising:
getting first input data including data selected from the group of a total number of content pages of said printed product and a cover type of said printed product;
generating from said first input data a first digital representation of said printed product;
getting second input data, different from said first input data; and
refining said first digital representation of said printed product by using said second input data, thus obtaining a second digital representation of said printed product.

2. The method according to claim 1 further comprising:
getting third input data, different from said first input data and different from said second input data; and
refining said second digital representation of said printed product by using said third input data, thus obtaining a third digital representation of said printed product.

3. The method according to claim 1 further comprising:
changing said second input data; and
refining said first digital representation of said printed product by using said changed second input data, thus obtaining a changed second digital representation of said printed product.

4. The method according to claim 1 further comprising producing said printed product.

5. The printed product obtained by the method according to claim 4.

6. A method for making a digital representation of a printed product comprising:
getting first input data including data selected from the group of a total number of content pages of said printed product and a cover type of said printed product;
generating from said first input data a first digital representation of said printed product;
getting second input data including a number of sections of said printed product; and
refining said first digital representation of said printed product by using said second input data, thus obtaining a second digital representation of said printed product.

7. The method according to claim 6 further comprising:
getting third input data, different from said first input data and different from said second input data; and
refining said second digital representation of said printed product by using said third input data, thus obtaining a third digital representation of said printed product.

8. The method according to claim 6 further comprising:
changing said second input data; and
refining said first digital representation of said printed product by using said changed second input data, thus obtaining a changed second digital representation of said printed product.

9. A method for making a digital representation of a printed product comprising:
getting first input data derived from specifications of said printed product as determined by a customer;
generating from said first input data a first digital representation of said printed product;
getting second input data different from said first input data and purely related to producing said printed product; and
refining said first digital representation of said printed product by using said second input data, thus obtaining a second digital representation of said printed product.

10. The method according to claim 9 further comprising:
getting third input data, different from said first input data and different from said second input data; and
refining said second digital representation of said printed product by using said third input data, thus obtaining a third digital representation of said printed product.

11. The method according to claim 9 further comprising:
changing said second input data; and
refining said first digital representation of said printed product by using said changed second input data, thus obtaining a changed second digital representation of said printed product.

12. The method according to claim 9 further comprising producing said printed product.

13. The printed product obtained by the method according to claim 12.

14. A method for making a digital representation of a printed product comprising:
generating a first digital representation of said printed product from first input data;
associating, in said first digital representation of said printed product, content matter of said printed product to pages of said printed product;
getting second input data, different from said first input data; and
refining said first digital representation of said printed product by using said second input data, thus obtaining a second digital representation of said printed product.

15. The method according to claim 14 further comprising:
getting third input data, different from said first input data and different from said second input data; and
refining said second digital representation of said printed product by using said third input data, thus obtaining a third digital representation of said printed product.

16. The method according to claim 14 further comprising:
changing said second input data; and
refining said first digital representation of said printed product by using said changed second input data, thus obtaining a changed second digital representation of said printed product.

17. The method according to claim 14 further comprising producing said printed product.

18. The printed product obtained by the method according to claim 17.

19. A method for making a digital representation of a printed product comprising:
getting first input data including data selected from the group of a total number of content pages of said printed product and a binding method of said printed product;
generating from said first input data a first digital representation of said printed product;
getting second input data, different from said first input data; and
generating from said first and said second input data a second digital representation of said printed product.

20. The method according to claim 19 wherein said second input data include a number of sections of said printed product.

21. A computer program product for making a digital representation of a printed product, the computer program product comprising:
first program instructions for getting first input data including data selected from the group of a total number of content pages of said printed product and a cover type of said printed product;
second program instructions for generating from said first input data a first digital representation of said printed product;
third program instructions for getting second input data, different from said first input data; and
fourth program instructions for refining said first digital representation of said printed product by using said second input data, thus obtaining a second digital representation of said printed product.

22. The computer program product according to claim 21 further comprising a computer readable medium wherein said first, second, third and fourth program instructions are recorded on said medium.

23. A computer program product for making a digital representation of a printed product, the computer program product comprising:
first program instructions for getting first input data derived from specifications of said printed product as determined by a customer;
second program instructions for generating from said first input data a first digital representation of said printed product;
third program instructions for getting second input data different from said first input data and purely related to producing said printed product; and
fourth program instructions for refining said first digital representation of said printed product by using said second input data, thus obtaining a second digital representation of said printed product.

24. The computer program product according to claim 23 further comprising a computer readable medium wherein said first, second, third and fourth program instructions are recorded on said medium.

25. A system for making a digital representation of a printed product, the system comprising:
a first input module for getting first input data including data selected from the group of a total number of content pages of said printed product and a cover type of said printed product;
a generator for generating from said first input data a first digital representation of said printed product;
a second input module for getting second input data, different from said first input data; and
a refinement module for refining said first digital representation of said printed product by using said second input data, thus obtaining a second digital representation of said printed product.
